(19) United States
(12) Patent Application Publication
(10) Pub. No.: US 2004/0152492 A1
(43) Pub. Date: Aug. 5, 2004

(54) Antenna interface protocol

(76) Inventor: Andrew Gray, Orland Hills, IL (US)

Correspondence Address: Eric D Cohen, Welsh & Katz, 22nd Floor, 120 South Riverside Plaza, Chicago, IL, 60606, US

(21) Appl. No.: 10/399,099

(22) PCT Filed: Mar. 12, 2003
(86) PCT No.: PCT/US03/07742

(30) Foreign Application Priority Data
May 14, 2001 (GB) 0111775.3

(51) Int. Cl. H04M 1/00; H04B 1/38

(52) U.S. Cl. 455/562.1; 455/561

(57) ABSTRACT

A method and apparatus are provided for remotely controlling a plurality of electrically tiltable antenna from an operations and maintenance center. The method includes the steps of transferring a data frame containing a fragmentation field between the operations and maintenance center and a first controller of the plurality of electrically tiltable antenna and broadcasting the data frame to at least some other controllers of the plurality of electrically tiltable antenna when the fragmentation field contains a point to multipoint indicator.

This application claims the benefit of priority from Provisional Application Serial No. 60/364,505, entitled Antenna Interface, and filed on Mar. 15, 2002. Provisional Application Serial No. 60/364,505 is hereby incorporated by reference in its entirety.

### FIELD OF THE INVENTION

The field of the invention relates to the control of antenna and more particularly to the control of antenna from remote locations.

### BACKGROUND OF THE INVENTION

Cellular telephones and the systems that support such telephones are generally known. The convenience and portability of such devices have become an indispensable part of everyday life. Such devices are often used within automobiles, in shopping malls, in waiting lines or where ever a person finds the need to communicate. Cell phones have even begun to replace the hardwired telephones in the homes of many people.

Within any geographic area there may be many cellular telephones in simultaneous use. To support the use of cellular telephones in any particular area, one or more base stations may be provided. The base stations may function as an interface with other cellular telephones and with local or long-distance carriers.

In order to service large numbers of cellular telephones, the cellular system has been allocated a relatively large radio frequency (rf) spectrum by the Federal Communication Commission (FCC). However, the relatively large spectrum is not adequate in some locals.

To maximize the use of the rf spectrum, some form of frequency reuse is implemented among the base stations. Directional antenna have been used as a mechanism of frequency reuse.

One of the key elements of frequency reuse is to reduce the output power of the cellular telephone and base station to a lowest possible power level. Reducing the power reduces mutual interference and distance between frequency reusing telephones of the cellular system.

While such processes are effective, the progressive increase in cellular use continues to strain the capacity of the cellular system. In addition, dynamic variations in cellular traffic (e.g., daily and seasonal, spatial and temporal fluctuations in traffic density, etc.) all contribute to reduce the stability and reliability of the cellular system. Other factors include management of hand-over between cells to minimize dropped call rates. In order to improve the performance of the cellular system under any of these conditions, a need exists for better methods of controlling the power levels of cellular telephones.

### BRIEF DESCRIPTION OF THE DRAWINGS

FIG. 1 depicts a communication system in accordance with an illustrated embodiment of the invention;

FIG. 2 depicts a controller arrangement that may be used with the system of FIG. 1;

FIG. 3 depicts a frame structure that may be used with the controller of FIG. 2;

FIG. 4 depicts a bit map of the frame of FIG. 3;

FIG. 5 depicts controller registration command and response frames that may be used with the system of FIG. 2;

FIG. 6 depicts controller tag number assignment and response frames that may be used with the system of FIG. 2;

FIG. 7 depicts tag number assignment and response frames that may be used with the system of FIG. 2;

FIG. 8 depicts a map antenna parameters command frame that may be used with the system of FIG. 2;

FIG. 9 depicts a map antenna parameters response frame that may be used with the system of FIG. 2;

FIG. 10 depicts calibration instruction and response frames that may be used with the system of FIG. 2;

FIG. 11 depicts get controller instruction and response frames that may be used with the system of FIG. 2;

FIG. 12 depicts update firmware instruction and response frames that may be used with the system of FIG. 2;

FIG. 13 depicts get controller antenna configuration instruction and response frames that may be used with the system of FIG. 2;

FIG. 14 depicts restore original controller configuration instruction and response frame that may be used with the system of FIG. 2;

FIG. 15 depicts set electrical downtilt instruction and response frames that may be used with the system of FIG. 2; and

FIG. 16 depicts read electrical downtilt instruction and response frames that may be used with the system of FIG. 2.

Table of Acronyms

BTS—Base Transceiver Station

AC—Antenna Controller

FCC—Federal Communications Commission

FFT—Frame Format Type

FRAG—Fragmentation

MAP—Map Antenna Parameters

MSC—Mobile Switching Center

OMC—Operations Maintenance Center

PSTN—Public Switch Telephone Network

RET—Remote Electrical Downtilt

REDT—Read Electrical Downtilt

rf—radio frequency

RSI—Received Signal Indicated

WAN—Wide Area Network

### DETAILED DESCRIPTION OF AN ILLUSTRATED EMBODIMENT

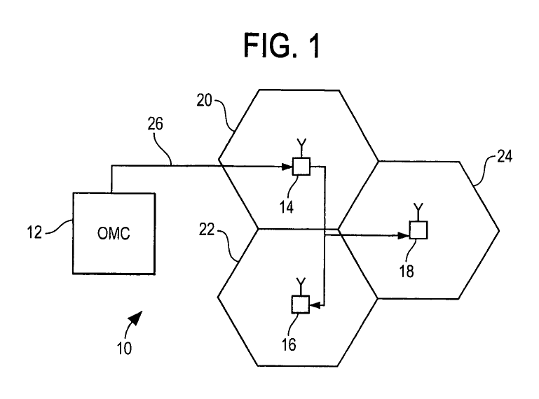

FIG. 1 is a block diagram of a cellular communication system 10 using adjustable downtilt, shown generally in accordance with an illustrated embodiment of the invention. Such a system 10 may include an operations and maintenance center (OMC) 12 and a number of base transceiver stations (BTSs) 14, 16, 18, where each BTS 14, 16, 18 may provide cellular service to cellular devices (e.g., telephones, pages, palm pilots, etc.) within its own respective service coverage area 20, 22, 24.

Each BTS 14, 16, 18 may be connected, in turn, to a mobile switching center (MSC) and public switch telephone network (PSTN) (not shown). Calls may be placed among cellular devices through the MSC or PSTN as is generally known in the art.

The OMC 12 generally functions to maintain and operate the BTSs 14, 16, 18. The OMC 12 in combination with the MSC may function to monitor the operation of transceivers, measure signal levels during cellular calls and perform call handoffs when signal levels fall below certain predetermined threshold values.

The monitoring and minimization of signal levels are a key feature for the efficient operation of any cellular system 10. The minimization of the strength of signals transmitted by the BTSs 14, 16, 18 and the cellular devices allows for the efficient reuse of frequencies in nearby cells 20, 22, 24.

The control of signal strength in cellular telephone calls between cellular devices and the BTSs 14, 16, 18 may be performed in two ways. One way is to monitor a received signal indicated (RSI) strength from the cellular device and adjust the power of transmission from the base station and cellular device according to some threshold value. Another way of reducing RSI is to adjust an electrical downtilt of the antenna of the BTS 14, 16, 18.

As is known, electrical downtilt is a version of beam forming that preferentially transmits and receives a signal at a particular angle relative to the antenna. Controlling downtilt is more effective than the use of power control by itself because downtilt functions to attenuate signals that are not within the preferential receiving angle of the electrically downtilted antenna.

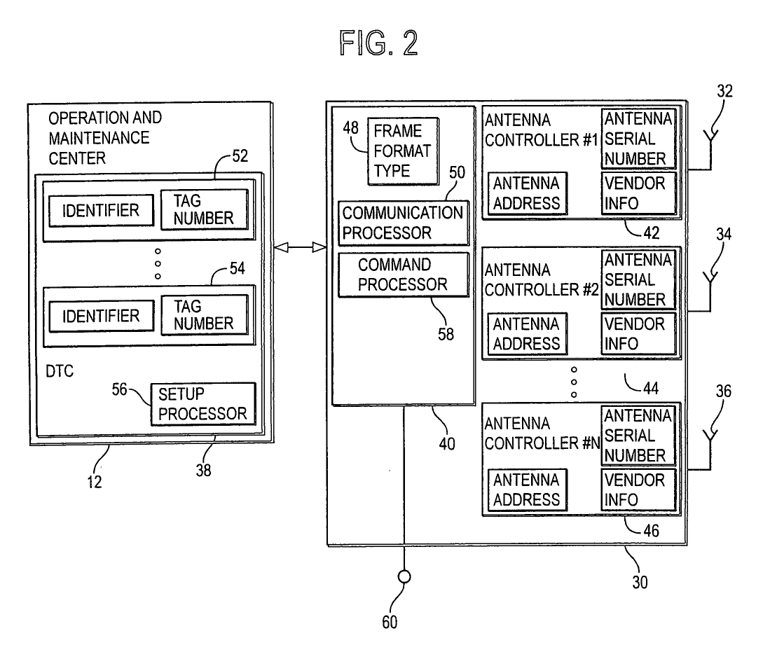

FIG. 2 is a simplified block diagram of the OMC 12 of FIG. 1 and a single BTS (now labeled 30) similar to those shown in FIG. 1. As would be known to those of skill in the art, the BTSs 14, 16, 18 of FIG. 1 may be provided with a number of antenna. Accordingly, the representative BTS 30 of FIG. 2 is shown with three antenna 32, 34, 36. However, any number of antenna may be associated with any particular BTS 14, 16, 18, 30.

Control of the electrical downtilt on any particular antenna 32, 34, 36 may be provided through an OMC Network Management User Interface (Network Manager) 38 within the OMC 12 and a BTS Antenna Controller (BTS AC) 40 within each BTS 14, 16, 18. While FIG. 2 shows a set of logical connections between antenna 32, 34, 36 and BTS AC 40, the actual connection between the BTS AC 40 and antenna 32, 34, 36 may be in the form of a common data bus. Control information may be exchanged between the Network Manager 38 within the OMC 12 and the CTR of the Network Manager 30 by the exchange and processing of a unique set of data frames, as described below.

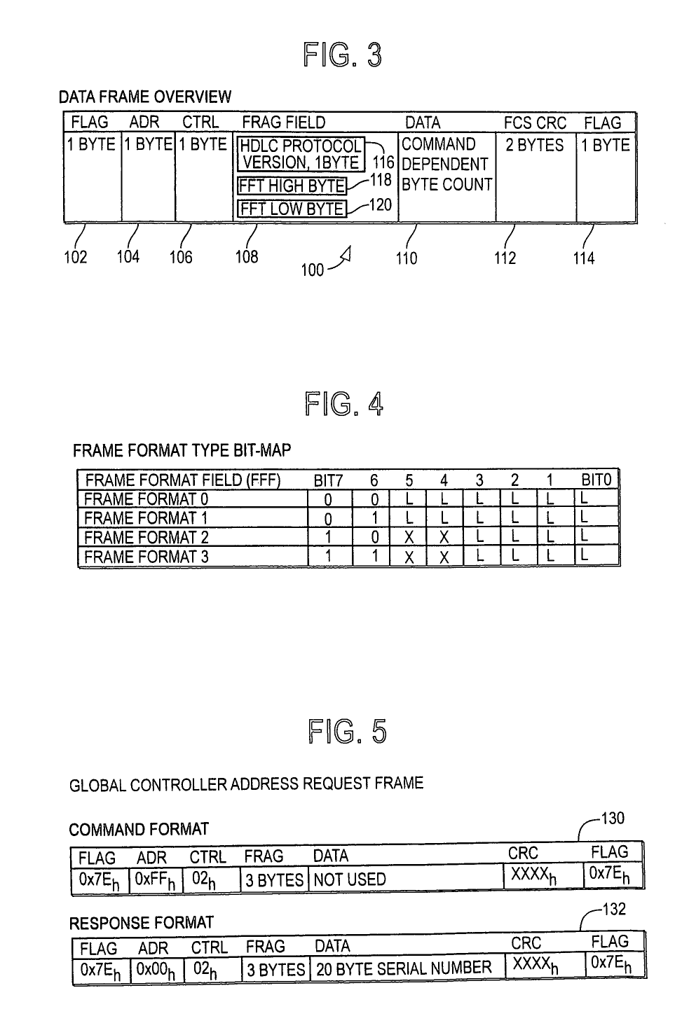

FIG. 3 depicts an example of the data frame 100 that may be used for exchanging downtilt control and setup information between the OMC 12 and the BTS AC 40 of the BTS 30. As shown, the data frame 100 may include seven fields 102, 104, 106, 108, 110, 112, 114. A first field 102 and a last field 114 may serve the function of flags to mark the beginning and end of the frame 100. The flags 102, 114 may be provided in the form of some easily recognizable bit sequence (e.g., 0×7Eₕ) and appropriate length (e.g., one byte).

A second field 104 may be an address field of an appropriate length (e.g., one byte). The address field may be used for addressing remote electrical downtilt (RET) antenna BTS ACs 40 in the context of a Wide Area Network (WAN) to allow the OMC 12 to control more than one antenna BTS site at a remote location. The address parameters of devices such as antennas and tower mounted amplifiers are subordinated to the BTS AC 40 being addressed in the address field 104 and are included in the data payload field 110 as device specific commands (discussed in more detail below).

A third field 106 provides control information regarding control of the electrical downtilt. This command field 106 may be one byte long and may support up to 127 different commands that control how the frame 100 is interpreted and processed by the BTS AC 40.

The command field 106 may be used to forward commands one-at-a-time or commands may be forwarded two-at-a-time (in a multiple instance format) where the commands are of the same type to reduce the volume of traffic needed to achieve a specific objective.

To issue commands in the command field 106 under either single or multiple instance command format, the command structure described below may be used. The command field allows 127 commands, but only nine of these will be used for the protocol described herein. Expansion room has been provided so that future protocols don't require major software revisions. A command can be issued in a multiple instance format so that multiple command frames are not needed for multiple commands of the same type issued to he same controller, all that is required in this case is a modified command code and an extended parameter set.

Under a single instance format, the command structure may have the form “7Fₕ && XXₕ” where “7Fₕ” is the control bit-mask, “&&” is a byte-wise logical AND function and “XXₕ” is the Command byte (i.e., the most significant bit in the control word is zero). Under the multiple instance format, the command may have the form “80ₕ∥XXₕ” where “80ₕ” is the control mask, “∥” is a byte-wise logical OR function and “XXₕ” is the command byte (i.e., the most significant bit in the control word is one).

In addition to other commands discussed in more detail below, the control field 106 may used to request the retransmission of frames 100. In the event of frame errors, frame repeat requests initiated by the OMC 12 may be broadcast using the HDLC “S” frame format and parameters as described in ISO/IEC 13239: 2000(E) available from the International Standards Organization. The controller that sent the erroneously received frame in the most recent time interval (e.g., 1 second) may respond by repeating the last frame.

The fourth field 108 is referred to as the fragmentation (FRAG) field. The FRAG field 108 is a data link layer information sub-field used to define the HDLC protocol version and the length of the data payload in the data field 110. The fragmentation field also be used to control distribution of the frame 100 among connected BTS ACs 40 of the electrically tiltable antenna system.

The FRAG field 108 may, in turn, be divided into a first sub-field 116 and second sub-field 118, with an optional third sub-field 120, each of an appropriate length (e.g., one byte each). The first sub-field 116 may include a one-byte parameter specifying the HDLC protocol version used (e.g., ISO/IEC 13239 2000(E)).

The second and third subfields 118, 120 within the FRAG field 108 may include frame format type (FFT) information. The first two most significant bits (MSBs) (i.e., bits 6 and 7) of the second sub-field 118 may be used to specify frame distribution information and lowest 6 bits (i.e., bits 0-5) may be used to specify a length of the data field 110.

The FFT identifiers are alphanumeric values that controls broadcasting of the frame to the antenna BTS AC 40. As used herein broadcasting means the intentional routing to all antenna controllers in a particular network or subnetwork.

FIG. 4 is a bit map of the second subfield 118 depicting FFT names on the left and possible bit values on the right. As may be noted in FIG. 4, four FFTs are defined in bit positions 6 and 7 with Xs in bit positions 4 and 5 of Frame formats 2 and 3 to allow for the possibility of defining additional FFTs. The character “L” in bit positions 0-5 indicates the length of the data field 110.

As shown, the first FFT (i.e., Frame Format 0) is defined by zeros in bit positions 6 and 7. Frame Format 0 may define a frame 100 used for point to point communications between a single terminal 40 and host 12 using short frames with up to 2⁶-1 bytes (i.e., 63 bytes in length) included within the data field 110.

The second FFT (i.e., Frame Format 1) may be defined by a one in bit position 6 and a zero in bit position 7. Frame Format 1 may be used in a multipoint communication mode for communication between the host 12 and a number of BTS ACs 40 using a short packet length of up to 2⁶-1 bytes (i.e., 63 bytes in length) included within the data field 110.

The third FFT (i.e., Frame Format 2) is defined by a zero in bit position 6 and a one in bit position 7. Frame Format 1 may be used for point to point communication between the host 12 and a single BTS ACs 40 using an extended packet length of up to 2¹²-1 bytes (i.e., 4095 bytes in length) included within the data field 110. In this case, Frame Format 2 indicates that the third byte 120 is to be concatenated to the first byte 118.

The fourth FFT (i.e., Frame Format 3) is defined by a one in bit position 6 and a one in bit position 7. Frame Format 3 may be used for multipoint communications between the host 12 and a number of BTS ACs 40 using an extended packet length of up to 2¹²-1 bytes (i.e., 4095 bytes in length) included within the data field 110. Frame Format 3 indicates that the third byte 120 is to be concatenated to the first byte 118.

The frame 100 may include a fifth field 110 for data. The use of the data frame 110 will be discussed in more detail below.

The frame 100 is also provided with a FCS/CRC field 112 that may be 2 bytes long. The FCS/CRC field 112 may be used for CRC-16 type error detection and correction format to protect the integrity of large data packets such as those sent during file transfer or firmware upload. The format of the use of this field 112 may be described in document number AISG-23 from the Antenna Interface Standards Group. The field 112 may be a 16 bit CRC frame check sum that uses the polynomial x¹⁶+x¹²+x⁵+1, preset to 1 and the ones complement of the final remainder for detection and correction.

During a cold startup of the system 10, the OMC 12 may use the data frames 100 operating through the communication link 26 to identify and set up each BTS AC 40 within the system 10. Once the system 10 has been set up to operate under the control of the OMC 12, the OMC 12 may then proceed to operate and control the electrical downtilt level of each BTS 14, 16, 18.

In order to set up the BTSs 14, 16, 18, a setup processor 56 within the Network Manager 38 may first send out a global controller address request 130, as shown in FIG. 5. The BTS AC 40 at each BTS 14, 16, 18 may respond with the frame 132.

The request 130 may be sent under Frame Format 1 and may include the instruction “02h” in the control field 106 of the frame 100. A frame format processor 48 within the BTS AC 40 may read and decode the second portion 118 of the FRAG field 108 and recognize that the frame 130 is intended for the BTS ACs 40 of all BTSs 14, 16, 18. Accordingly, a communication processor 50 may replicate the frame 100 and pass it on to each BTS AC 40.

The request 130 is read by all controllers during site configuration and causes a sequence of controller responses that results in each BTS AC 40 revealing its 20 byte serial number (ID) (stored in flash RAM) to the Network Manager 38 of the OMC 12. A robust algorithm for preventing data packet collisions when BTS ACs 40 respond is provided for this purpose.

Within each BTS AC 40, a command processor 58 may read the control field 106 of the frame 130 and determine that the frame 130 is a request for the ID number. Accordingly, the command processor 58 may recover the ID number from flash RAM and compose the response 132.

The response may include an address of the Network Manager 38 in the address field 104 and the ID number in the data field 110. Otherwise, the response 132 is substantially the same as the request 130. In the request/response of this example, the data operand field 110 is only used during the controller response 132 where the data is the controller's address ID field.

As each ID of the BTS ACs 40 is received by the setup processor 56, the setup processor 56 may assign a controller tag number to the BTS AC 40. The associated controller ID number and tag number may each be saved in a particular controller file 52, 54.

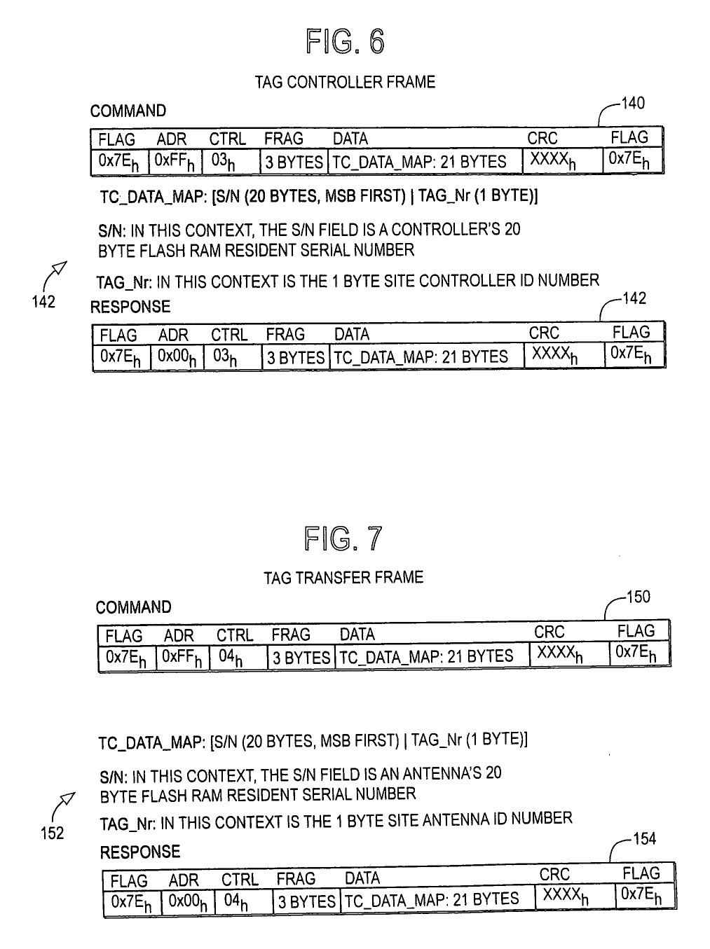

The setup processor 56 may then download the assigned controller tag number to each BTS AC 40 using a tag controller frame 140 (FIG. 6). As may be noted, the control field 106 of the frame 140 contains the instruction “03ₕ”

The tag controller frame 140 is a site configuration command that allows controllers to be tagged with a site specific 1 byte identification number. Valid tag numbers may have a range of from 1×01ₕ to 0×7Eₕ. The use of tag numbers allows the use of less verbose commands when addressing controllers after site configuration. This command cannot be used in a multiple instance mode as there can be only one unique tag number per addressed controller. Tag numbers F1ₕ and FFₕ may be reserved for error status reporting and global addressing (i.e., 0×FFₕ).

It should be noted that within the tag controller frame 140, the tag number and ID number are included within the data field 110. The FRAG field 108 may contain a Frame Format number of zero and the length may indicate a length of 21 bytes as shown by the data field key 142.

As the frame 140 is received, the command processor 58 recognizes the command “03ₕ”. Based upon the command “03ₕ”, the command processor 58 retrieves the data field 110 and compares the first 20 bytes with its own ID number. If a match is found, then the command processor 58 saves the tag number in its own memory as a shorthand address of the BTS AC 40.

Once the tag number is saved in memory, the command processor may respond to receipt of the tag controller frame 140. The response 142 may be an echo of the command with the address field 104 changed. In the event of an error, the command processor 58 may pass back an error code (e.g., F1ₕ-FFₕ) in the response's TAG_Nr field as shown in the key 142.

Once the BTS ACs 40 have been tagged, the Network Manager 38 may request a serial number of each antenna 32, 34, 36 from each BTS AC 40 and assign an antenna tag number to each antenna. In order to request a serial number of each antenna, the setup processor 56 may forward a tag antenna frame similar to frame 130 of FIG. 5 except that the control character may have the form “04ₕ” and the address field may contain the tag of the BTS AC 40. Since this may be a site specific command the Frame Format may be 0.

In response to the tag antenna request, a response similar to 132 may be returned except that the control field 106 would contain the character “04ₕ” and the data field would contain a 20 byte serial number of one of the antenna 32, 34, 36 along with the controller tag. In this case, the command processor 58 may retrieve a serial number from each antenna interface 42, 44, 46. In the case of the BTS AC 40 of FIG. 2, the controller 30 may return three versions of the response, each with a different serial number.

Upon receipt of a serial number of each antenna 32, 34, 36, the setup processor 56 may assign an antenna tag number to each antenna 32, 34, 36. The setup processor 56 may also associate the antenna tag number with the controller tag number in memory for addressing purposes.

Upon assigning an antenna tag number to each antenna, the setup processor 56 may return the frame 150 shown in FIG. 7. As shown in the key 152 of FIG. 7, the data field 110 may include the serial number of the antenna 32, 34, 36 and the antenna tag number. The BTS AC 40 may save the antenna tag number in an internal memory for referencing purposes.

As the BTS AC 40 receives each antenna tag number, the BTS AC 40 may return the frame 154 of FIG. 7. As above, the response 154 may be an echo of the frame 150 except for the address.

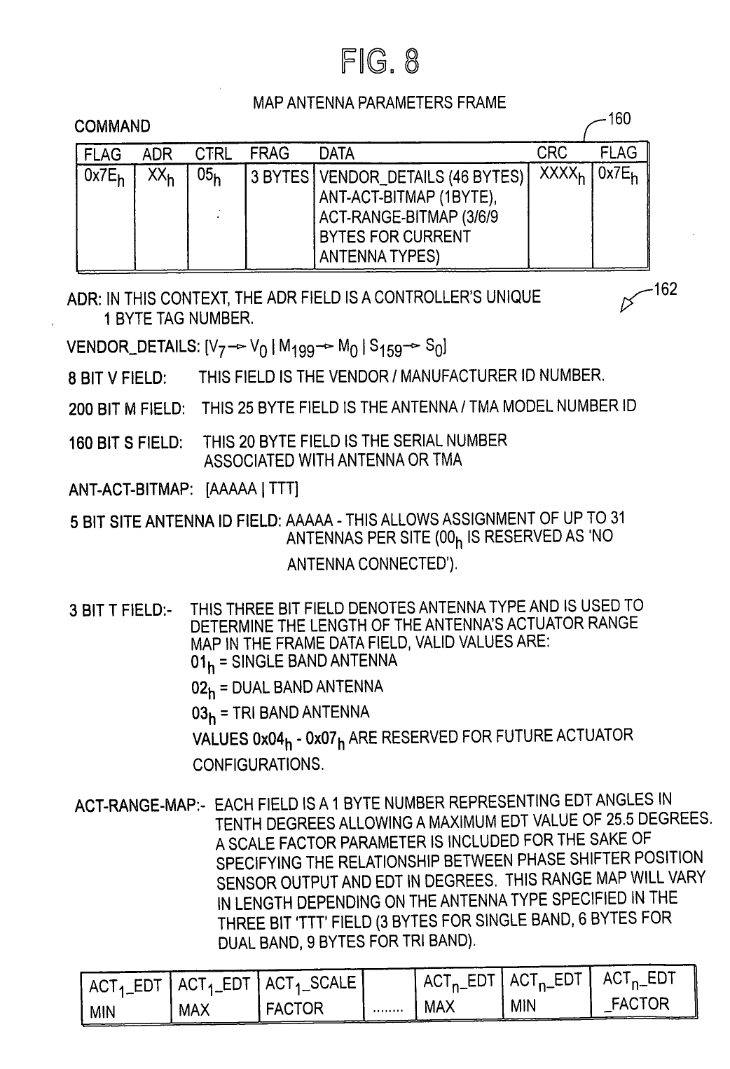

Once the Network Manager 38 has assigned antenna tags to the antenna 32, 34, 36, the Network Manager 38 may download a set of antenna parameters to each BTS AC 40 by sending a map antenna parameters (MAP) command 160 such as that shown in FIG. 8. The MAP command is a site configuration command that allows an associative mapping between logical antenna ID, antenna control algorithm type, antenna vendor and band actuator. An error response may be necessary in the event of an attempt to map an actuator to an antenna that doesn't exist within a selected controller, which may be returned in the data field of a response frame. When used in a multiple instance mode, the data field will vary in length depending on the number and the type of antennas used. This suggests that the FFT field will depend on the number of antennas being added in one command.

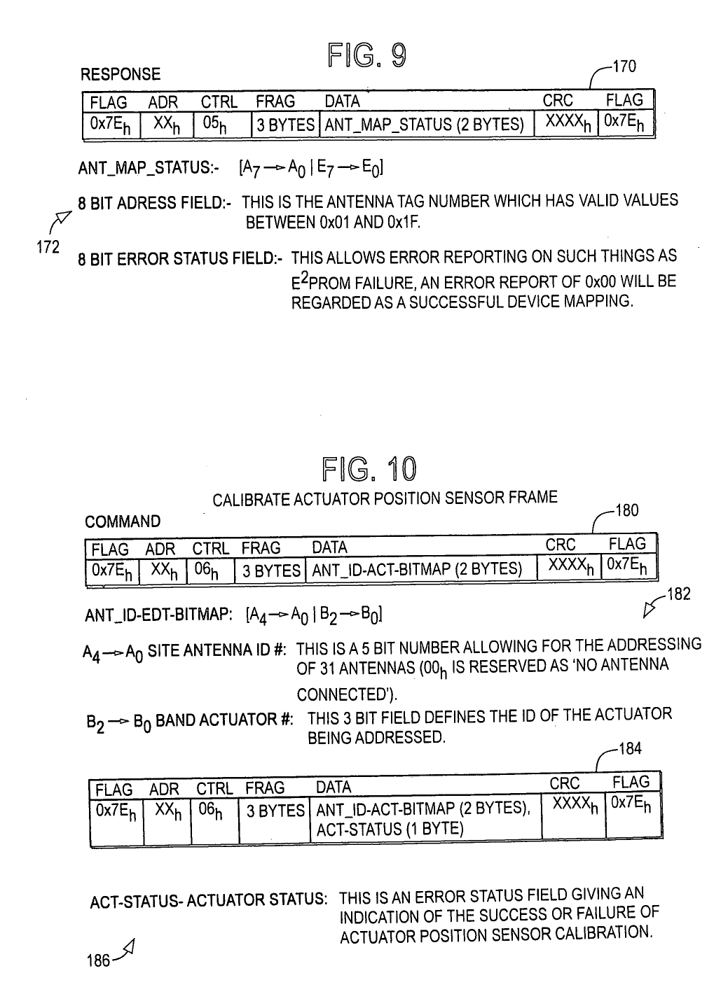

FIG. 9 depicts a response frame 170 to the MAP frame 160 from the Network Manager 38. As may be noted from the map key 172, a response from each antenna may be provided using the antenna key and any error codes, including an indication of a successful mapping. This is an echoed form of the command with confirmation of the port assignments. Port assignments which are returned as 000₂ (when a non-zero result was expected) indicates an assignment error.

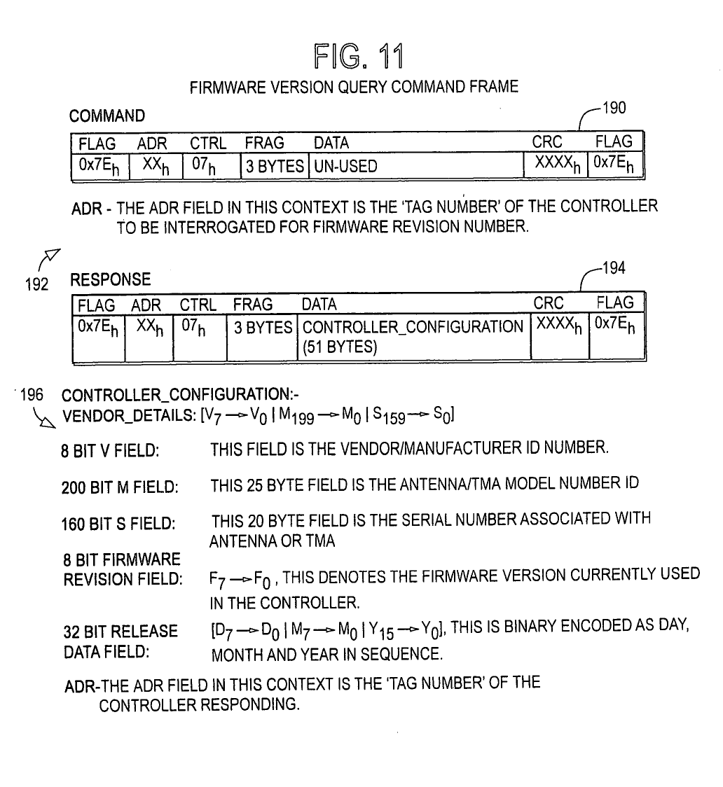

Following the downloading of antenna parameters, the Network Manager 38 may download a calibrate actuator position sensor (CAL) command 180 (FIG. 10). The CAL command 180 actuates the calibration function in a specified BTS AC 40 which results in the generation of a “look-up” table that contains the relationship between position sensor output voltage and electrical downtilt (EDT) angle. An error code will be sent in the data field of a response frame 184 if calibration fails. This function cannot be invoked on a regular basis as it involves writing to flash RAM which has a limited number of write cycles.

This frame is a point to multipoint command that allows a range of calibrations options from calibration of a single actuator position sensor to an entire site level calibration. Individual actuators are identified using the Ant_ID-ACT-BitMap (see keys 182, 186) in the data field and defaults to 0000h for a site level calibration. A selected actuator group calibration is achieved by setting the CTRL field to multiple instance mode (86ₕ) and may include the use of multiple Ant_ID-Act-BitMaps in the data field with an appropriate frame length parameter in the FFT field.

FIG. 11 shows a frame 190 that may be used by the Network Manager 38 to obtain a firmware release of an addressed controller (see key 192). An associated frame 194 may be returned showing details (see key 196).

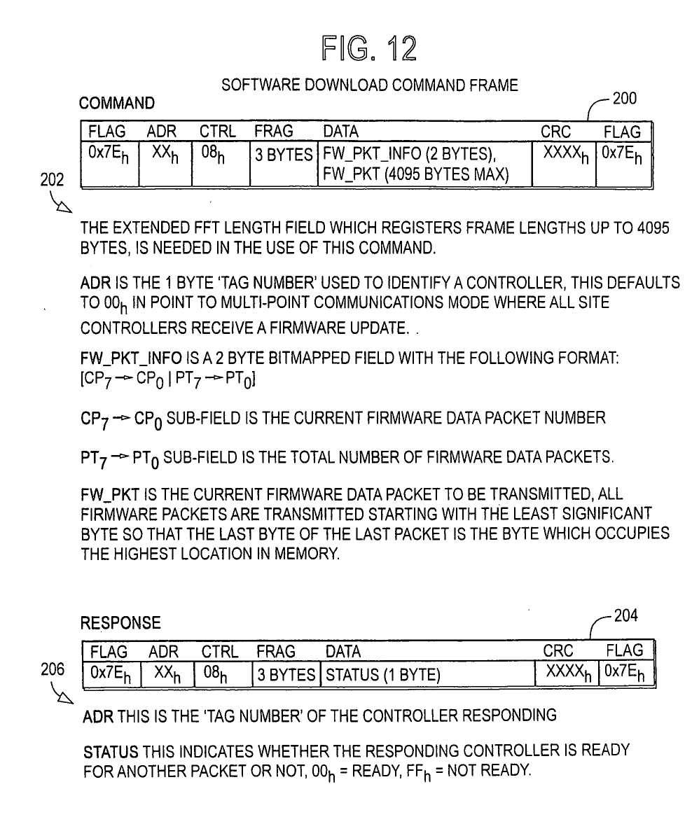

FIG. 12 shows a frame 200 and response 204 that allows the upgrading of existing controller firmware (UFW) within the BTS AC 40. The UFW frames 200, 204 can only be used locally through a port 60 using a PC provided with an RS232 or Ethernet interface. Full advantage is taken of the extended data packet format provided in the Frame Format options (FIG. 4). In downloading firmware to a controller, the PC will not send the next firmware packet (see keys 202, 206) until all participating controllers have sent their “Ready” response frames. This is advantageous to accommodate flash writing time and corrupt packet overhead.

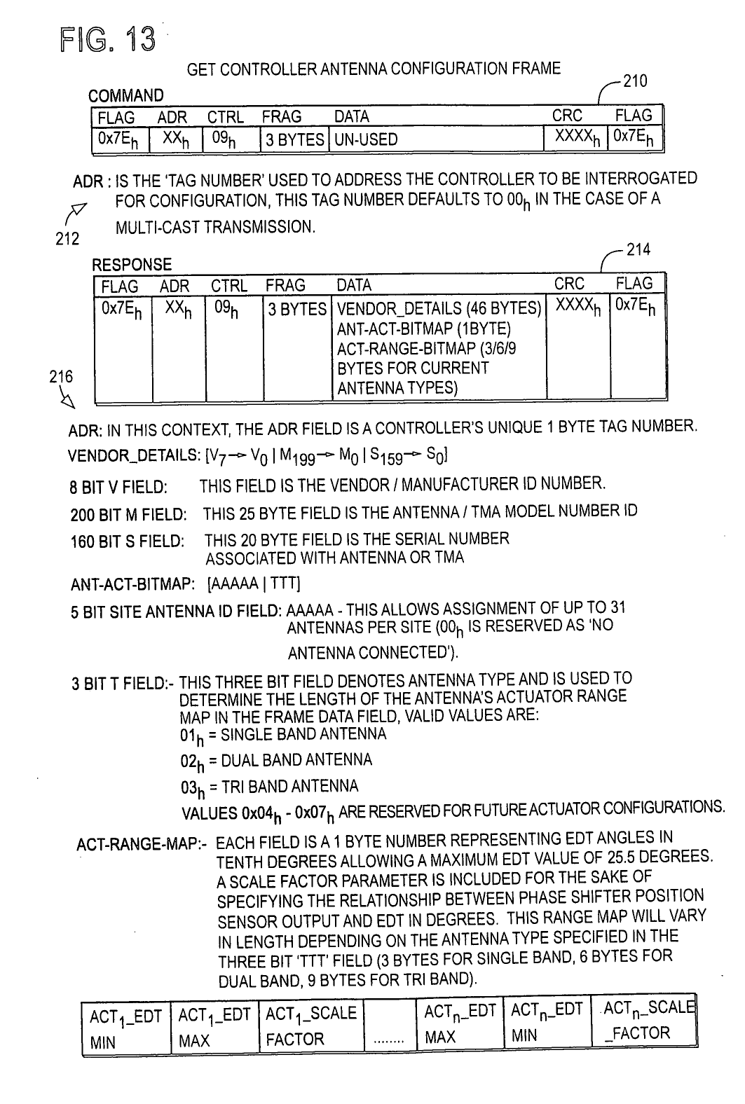

FIG. 13 shows get controller antenna configuation (GCAC) frames 210, 214 that allow an operator to obtain configuration data with regard to the system 10. As in prior examples, a particular control instruction (09ₕ) initiates collection of this information in the request frame 210. The data returned by the response 214 is detailed in the key 216.

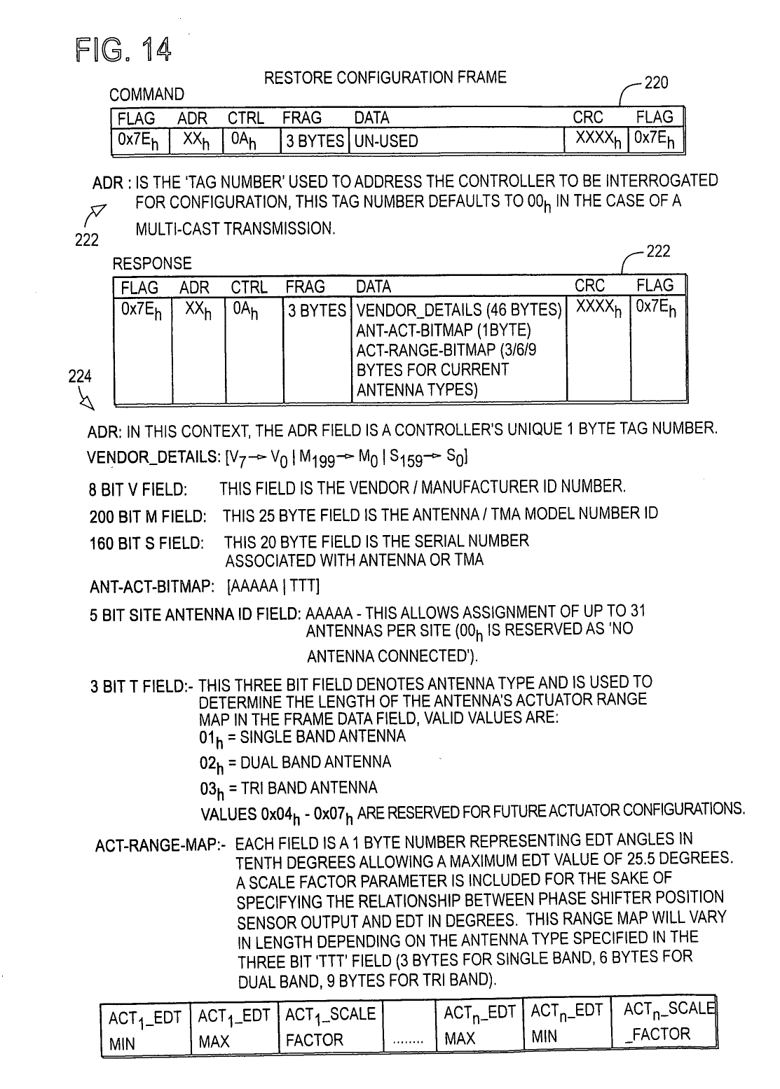

FIG. 14 shows frames 220, 224 that allow the Network Manager 38 to restore an original configuration to a BTS AC 40. A control instruction of “0Aₕ” may be used to activate this feature. The command frame 220 uses the tag number of the BTS AC 40 in the address field 104 (see key 222).

The response 224 details the controller's internally stored parameters (see key 224). Following restoration, the BTS AC 40 may automatically reboot and revert to the original parameters.

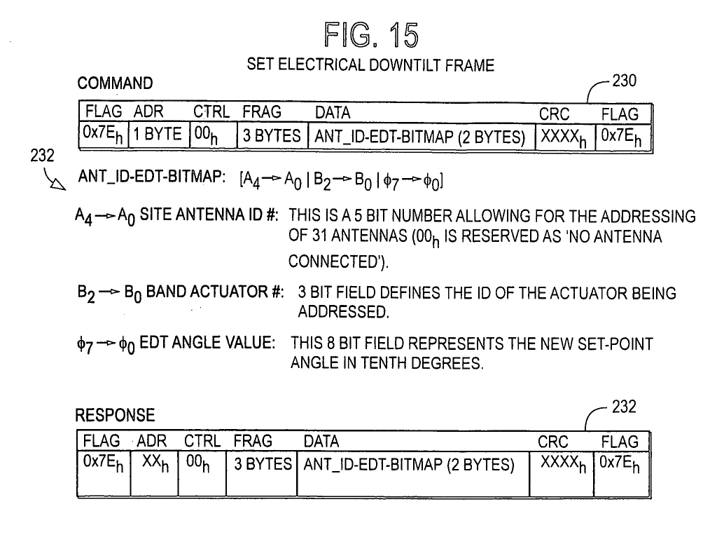

FIG. 15 shows a set electrical downtilt (SEDT) frame 230 that may be used by the DTC 30. In this case, the address field 104 would contain the tag number of the selected BTS AC 40. This may be a frame format 0 frame.

As shown in the key 232, the frame 230 includes a site antenna ID, a band actuator and an electrical angle downtilt value. The command processor 58 receives this frame 230 and decodes its values. Using the site antenna ID (antenna tag), the processor 58 identifies the antenna controller 42, 44, 46. Once the antenna controller 42, 44, 46 is identified, the command processor 58 may transfer the band actuator number and EDT angle value to the controller 42, 44, 46. The controller 42, 44, 46, in turn, executes the selected downtilt.

Once executed, the antenna controller 42, 44, 46 may return notification to the BTS AC 40. The BTS AC 40 may compose the response 232 to the Network Manager 38 confirming execution of the change.

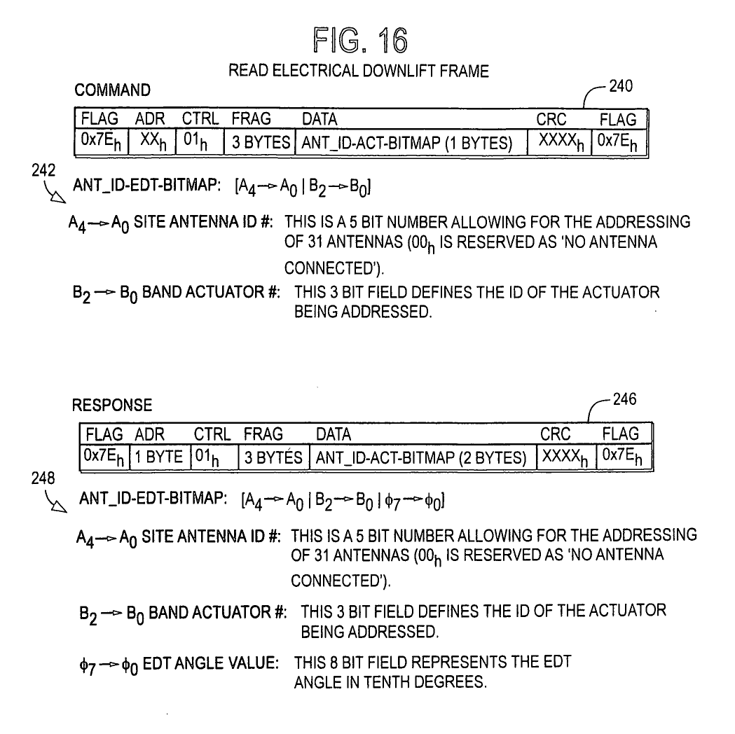

Once an EDT has been selected and sent to a BTS 12, 14, 16, the Network Manager 38 may periodically verify the settings of the BTSs 12, 14, 16. FIG. 16 shows a read electrical downtilt (REDT) frame 240 that may be used to verify a EDT setting. REDT performs the function of reading the electrical downtilt of a specified band actuator belonging to a specified antenna. As above, an address field 104 may contain the tag number of the BTS AC 40 of the BTS 12, 14, 16 to be interrogated. As shown in the key 242, a data field 110 of the REDT frame 240 contains an antenna tag and a band actuator.

Once received, the command processor 58 may interrogate the antenna controller 42, 44, 46 and return the REDT response frame 246. The response frame 246 contains information similar to the request frame 240 with the addition of an EDT angle value.

A specific embodiment of a method and apparatus for controlling electrical downtilt according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention, any and all modifications, variations, or equivalents that fall within the true spirit and scope of the basic underlying principles disclosed and claimed herein.

1. A method of remotely controlling a plurality of electrically tiltable antenna from an operations and maintenance center, such method comprising the steps of:
transferring a data frame containing a fragmentation field between the operations and maintenance center and a first controller of the plurality of electrically tiltable antenna; and
broadcasting the data frame to at least some other controllers of the plurality of electrically tiltable antenna when the fragmentation field contains a point to multipoint indicator.

2. The method of remotely controlling the plurality of antenna as in claim 1 further comprising decoding a frame length from the fragmentation field by a controller of one of the plurality of electrically tiltable antenna.

3. The method of remotely controlling the plurality of antenna as in claim 1 further comprising recovering a global controller address request from a control field of the data frame by a controller of one of the plurality of electrically tiltable antenna in response to the broadcast data frame.

4. The method of remotely controlling the plurality of antenna as in claim 3 wherein the step of recovering the global controller address request by the controller further comprises uploading a serial number of the controller from the controller to the operations and maintenance center in a data field of a data frame in response to the global controller address request.

5. The method of remotely controlling the plurality of antenna as in claim 4 wherein the step of transferring the serial number further comprises the operations center downloading a controller tag number to the controller of the electrically tiltable antenna for use by the operations and maintenance center as a data frame address of the controller.

6. The method of remotely controlling the plurality of antenna as in claim 5 wherein the step of downloading the controller tag number to the controller of the electrically tiltable antenna further comprises sending the controller tag number to the controller using the uploaded serial number of the controller as a data frame address of the controller.

7. The method of remotely controlling the plurality of antenna as in claim 5 further comprising the controller receiving a downloaded frame, decoding the controller tag number in a data field of the received frame, processing the frame and recovering a tag antenna instruction from the control field of the downloaded frame.

8. The method of remotely controlling the plurality of antenna as in claim 7 wherein the step of recovering the tag antenna instruction further comprises uploading an antenna serial number from the controller of the electrically tiltable antenna to the operations and maintenance center.

9. The method of remotely controlling the plurality of antenna as in claim 8 wherein the step of uploading the serial number further comprises the operations center downloading an antenna tag number to the controller of the electrically tiltable antenna as an address of an antenna of the controller.

10. The method of remotely controlling the plurality of antenna as in claim 9 further comprising the operations and maintenance center retrieving a set of antenna parameters in response to the antenna serial number.

11. The method of remotely controlling the plurality of antenna as in claim 10 further comprises downloading the set of antenna parameters to the controller.

12. The method of remotely controlling the plurality of antenna as in claim 11 further comprising the controller receiving an electrical downtilt instruction from the operations and maintenance center.

13. The method of remotely controlling the plurality of antenna as in claim 12 further comprising executing the downtilt instruction using the downloaded set of antenna parameters.

14. An apparatus for remotely controlling a plurality of electrically tiltable antenna from an operations and maintenance center, such apparatus comprising:
means for transferring a data frame containing a fragmentation field between the operations and maintenance center and a first controller of the plurality of electrically tiltable antenna; and
means for broadcasting the data frame to at least some other controllers of the plurality of electrically tiltable antenna when the fragmentation field contains a point to multipoint indicator.

15. The apparatus for remotely controlling the plurality of antenna as in claim 14 further comprising means for decoding a frame length from the fragmentation field by a controller of one of the plurality of electrically tiltable antenna.

16. The apparatus for remotely controlling the plurality of antenna as in claim 14 further comprising means for recovering a global controller address request from a control field of the data frame by a controller of one of the plurality of electrically tiltable antenna in response to the broadcast data frame.

17. The apparatus for remotely controlling the plurality of antenna as in claim 16 wherein the means for recovering the global controller address request by the controller further comprises means for uploading a serial number of the controller from the controller to the operations and maintenance center in a data field of a data frame in response to the global controller address request.

18. The apparatus for remotely controlling the plurality of antenna as in claim 17 wherein the means for transferring the serial number further comprises means for downloading a controller tag number to the controller of the electrically tiltable antenna for use by the operations and maintenance center as a data frame address of the controller.

19. The apparatus for remotely controlling the plurality of antenna as in claim 18 wherein the means for downloading the controller tag number to the controller of the electrically tiltable antenna further comprises means for sending the controller tag number to the controller using the uploaded serial number of the controller as a data frame address of the controller.

20. The apparatus for remotely controlling the plurality of antenna as in claim 18 further comprising means for decoding the controller tag number in a data field of the received frame, processing the frame and recovering a tag antenna instruction from the control field of the downloaded frame.

21. The apparatus for remotely controlling the plurality of antenna as in claim 20 wherein the means for recovering the tag antenna instruction further comprises means for uploading an antenna serial number from the controller of the electrically tiltable antenna to the operations and maintenance center.

22. The apparatus for remotely controlling the plurality of antenna as in claim 21 wherein the means for uploading the serial number further comprises means for downloading an antenna tag number to the controller of the electrically tiltable antenna as an address of an antenna of the controller.

23. The apparatus for remotely controlling the plurality of antenna as in claim 22 further comprising means for retrieving a set of antenna parameters in response to the antenna serial number.

24. The apparatus for remotely controlling the plurality of antenna as in claim 23 further comprises means for downloading a set of antenna parameters to the controller.

25. The apparatus for remotely controlling the plurality of antenna as in claim 24 further comprising means for receiving an electrical downtilt instruction from the operations and maintenance center.

26. The apparatus for remotely controlling the plurality of antenna as in claim 25 further comprising means for executing the downtilt instruction using the downloaded set of antenna parameters.

27. An apparatus for remotely controlling a plurality of electrically tiltable antenna from an operations and maintenance center, such apparatus comprising:
a data frame adapted to transfer a fragmentation field between the operations and maintenance center and a first controller of the plurality of electrically tiltable antenna; and
a communication processor adapted to broadcast the data frame to at least some other controllers of the plurality of electrically tiltable antenna when the fragmentation field contains a point to multipoint indicator.

28. The apparatus for remotely controlling the plurality of antenna as in claim 27 further comprising a global controller address request decoded from a control field of the data frame by a controller of one of the plurality of electrically tiltable antenna.

29. The apparatus for remotely controlling the plurality of antenna as in claim 28 further comprising a serial number of the controller uploaded from the controller to the operations and maintenance center in a data field of a data frame in response to the global controller address request.

30. The apparatus for remotely controlling the plurality of antenna as in claim 29 further comprising a controller tag number downloaded to the controller of the electrically tiltable antenna.

31. The apparatus for remotely controlling the plurality of antenna as in claim 30 wherein the controller tag number further comprises a data frame address of the controller.

32. The apparatus for remotely controlling the plurality of antenna as in claim 27 further comprising a tag antenna instruction decoded from the control field of the downloaded frame.

33. The apparatus for remotely controlling the plurality of antenna as in claim 32 wherein the decoded tag antenna instruction further comprises an antenna serial number uploaded from the controller of the electrically tiltable antenna to the operations and maintenance center.

34. The apparatus for remotely controlling the plurality of antenna as in claim 33 further comprising an antenna tag number downloaded to the controller of the electrically tiltable antenna as an address of an antenna of the controller.

35. The apparatus for remotely controlling the plurality of antenna as in claim 34 further comprising a set of antenna parameters downloaded to the controller in response to the antenna serial number.

36. The apparatus for remotely controlling the plurality of antenna as in claim 35 further comprising an electrical downtilt instruction downloaed to the controller from the operations and maintenance center.

37. A method of remotely controlling a plurality of electrically tiltable antenna from an operations and maintenance center, such method comprising the steps of:
transferring a data frame containing a frame format type identifier between the operations and maintenance center and a first controller of the plurality of electrically tiltable antenna; and
broadcasting the data frame to at least some other controllers of the plurality of electrically tiltable antenna based upon a content of the frame format identifier.

38. A method of remotely controlling a plurality of electrically tiltable antenna from a central controller, such method comprising the steps of:
transferring a data frame between the central controller and a first controller of the plurality of electrically tiltable antenna;
identifying a purpose of the data frame by incorporating a frame format type identifier into the data frame; and
executing the data frame within at least some of the plurality of controllers of the plurality of antenna based upon the incorporated frame type identifier.
